(19) United States
(12) Patent Application Publication
(10) Pub. No.: US 2006/0283741 A1
(43) Pub. Date: Dec. 21, 2006

(54) Shipping, storage and display packaging for collapsible-shade lamps

(75) Inventor: Chou Shih Bin, Taipei (TW)

Correspondence Address: ZITO TLP, 26005 RIDGE ROAD, SUITE 203, DAMASCUS, MD, 20872, US

(73) Assignee: Canel Lighting Co. Ltd.

(21) Appl. No.: 11/154,318

(22) Filed: Jun. 16, 2005

(51) Int. Cl. F21S 8/08; B65D 85/42

(52) U.S. Cl. 206/418; 362/414

(57) ABSTRACT

A lamp packaging device provides a useful shipping and storage container and convenient display box for lamps with collapsible-shades. In a first embodiment, the device comprises a shell with a bottom, trunk and hood. A base suitable for supporting a lamp is placed within the bottom during assembly. A collapsible lampshade is placed within the trunk over which an insert is placed, securing the shade for shipment. The lamp is placed on the base and secured to the device via a tie from the hood to the top of the lamp. A second embodiment provides for nesting of a pair of devices during shipment. A third embodiment provides for packaging of a pair of lamps and shades within one device. A fourth embodiment allows packaging of a lamp without a shade. Simple blank design renders productive assembly of the device, and easy-load features make packing a lamp quick and efficient.

### FIELD OF THE INVENTION

The present invention relates to the field of packaging for electric lamps. More specifically, the present invention is a packing, shipping, storage and display packaging device for lamps with collapsible shades.

### BACKGROUND OF THE INVENTION

Many types of packaging cartons are available in the marketplace which are prepared from blanks made from cardboard, plastic or other suitably flexi-stiff materials. Flexi-stiff materials are generally flexible enough for bending into place during assembly but stiff enough to retain their shape afterwards. The blanks are pre-dimensioned, pre-creased and pre-cut into sections such that when the so-defined areas are separated, folded and inter-connected, the assembled product is suitable for use in the packaging, shipping, storage and/or display of an article for which it is designed to contain.

Many versions of packaging cartons have been designed for use with lamps and lampshades. Some of these provide containment for the lamps with a separate containment for the shades. Others provide for joint packaging of the lamp and shade. For example, Humphrey in U.S. Pat. Nos. 6,325,209 and 6,419,085 teaches the use of packaging designed to store and protect the lamp during shipment and display. One embodiment displays only the lamp, and another displays the lamp and part of the shade.

However, the available packaging concepts do not provide for the most efficient means of packaging in all situations, nor are they suitable for every type of lamp and shade. In particular, in the case of a lamp with a collapsible shade, such as the lampshade of Chou as described in U.S. Pat. No. 6,851,836, a more efficient and appropriate solution is desirable.

### SUMMARY OF THE INVENTION

A lamp packaging device is disclosed which provides a useful shipping and storage container as well as a convenient display box for lamps with collapsible-shades. Simplicity of the blank design renders productive assembly of the device, and the easy-load features make packing of a lamp within the device quick and efficient. In addition, the ability to substitute alternate detail embodiments within the basic design of the product allows the basic packaging concept to be used for many alternative lamp and shade designs.

A first embodiment of the invention is shown in FIG. 5B. It comprises a carton made of cardboard or similar suitable material with a shell comprising a bottom, a central trunk and a hood-like top. The shell is formed from a single, two-dimensional blank of material which has been cut and scored along predetermined lines. A depiction of the blank is shown in FIG. 1. When the blank is separated and folded along the lines, it forms the three-dimensional shell. Stored within the bottom section is a separable base unit, made of the same material types as the shell. It too is fabricated from a single blank of material. The base provides suitable shock absorption for the entire lamp and also provides a location-fixing feature for the lamp at its base. This feature comes in the form of a circular or other shaped cut-out which matches the base or feet of the lamp. Situated within the central trunk are the collapsible shade and mounting harp that go with the lamp. The shade and harp are covered and held in place by a removable panel insert. The insert is made from a single blank and contains a window with a clear covering, allowing a purchaser of the lamp to view the color and texture of the shade without having to have it assembled. In this way, the customer may view both the lamp and shade before purchase without requiring the vendor to utilize valuable floor space needed for a fully-assembled shade. The compactness of the shade compartment in the trunk leverages the collapsibility of the shade and further minimizes shipping volume. In addition, at the base of the insert is a cut-out, sized and shaped to help secure the base of the intended lamp when the lamp is fixed on the base and the insert is in place.

To load the lamp into the packaging device, first the lampshade, supports, if any, and support harp are placed into the central trunk. Next the lamp is set into the lamp locating feature, in this case, the hole on the base unit, and is secured by a tie-wire or similar arrangement passed through holes in the hood and around the top of the lamp. Finally, the insert is slid into the top of the hood compartment and down onto the top of the base unit, sealing the shade and supports within the central trunk and locking the base of the lamp into the location-fixing hole in the base unit via the cutout in the bottom of the insert. A finger-hole carry slot in the rear of the hood provides ease of carrying the packaged lamp.

A second embodiment, as shown in FIG. 12, provides a packaging carton with an off-center bottom and base arrangement. The off-center arrangement permits nesting of two packaging cartons, offering further protection for both packaged lamps during shipment and storage. The nesting, either face-to-face or face-to-inverted-face, further reduces the shipping volume of the knocked-down and packaged lampshade and lamp.

A third embodiment takes the form a double-lamp package. The bottom receptacle and associated base are both wide enough to accommodate a pair of lamps in a side-by-side arrangement. The central trunk is configured to provide a double-depth storage space suitable for a pair of collapsible shades, supports, if any, and mounting harps. This minimizes shipping volume in cases where the lamps and shades are to be shipped as pairs of units.

A fourth embodiment provides a carton which holds a single lamp, but does not provide space for a collapsible shade behind the insert. The storage space behind the insert is sized to accommodate only a mounting harp. A lamp shade is not packaged with the lamp, but may be packaged separately.

Each embodiment may contain special adaptive features, which are sized and shaped, included or not included as befits the particular lamp being stored in the device. For example, the insert may or may not have a window hole which may or may not be covered by a clear covering, and the size and shape of each embodiment will vary depending on the nature of the lamp(s) and associated shade(s), if any, being stored. These adaptive features may be provided without departing from the inventive concept.

### BRIEF DESCRIPTION OF THE DRAWINGS

Exemplary embodiments of the invention are discussed hereinafter in reference to the following drawings, in which:

FIG. 1 is a two-dimensional view of the shell blank of the first embodiment of the invention.

FIG. 2 repeats the view from FIG. 1. However, this view also depicts an end view of the shell highlighting the preliminary blank folds required to produce a tubular partial-assembly.

FIG. 3 is a perspective view of the shell of the first embodiment of the invention without the base or insert installed.

FIG. 4 is a perspective view of the shell of the first embodiment of the invention with the base but not the insert installed.

FIG. 5A is a perspective view of the shell of the first embodiment of the invention with the base installed and the insert being installed by sliding said insert up into the hood of the shell.

FIG. 5B is a perspective view of the fully assembled device of the first embodiment of the invention with the base and insert installed within the shell.

FIG. 6 is a two-dimensional view of the blank of the base of the first embodiment of the invention.

FIG. 7 repeats the view from FIG. 6. However, this view also depicts an end view of the base highlighting the preliminary blank folds required to produce a tubular partial-assembly.

FIG. 8 is a view of the partially-assembled base showing the final blank folds required to produce a completed base assembly.

FIG. 9 is a two-dimensional view of the blank of the insert of the first embodiment of the invention.

FIG. 10 repeats the view from FIG. 9. However, this view also depicts an end view of the base highlighting the preliminary blank folds required to produce a U-shaped, ready-to-install assembly.

FIG. 11 is a section view through the first embodiment of the invention depicting a lamp and collapsible lampshade packaged within the device.

FIG. 12 is a perspective view of the second embodiment of the invention showing the off-set bottom and base arrangement which permits nesting of the inventive device.

FIG. 13 is a two-dimensional view of the blank for the shell of the second embodiment.

FIG. 14 repeats the view from FIG. 13. However, this view also depicts an end view of the shell highlighting the preliminary blank folds required to produce a tubular partial-assembly.

FIG. 15 is a perspective view of the third embodiment of the invention showing the side-by-side bottom and base arrangement which permits storing a pair of lamps within the inventive device.

FIG. 16 is a two-dimensional view of the blank for the base of the third embodiment depicting a pair of circular holes for positioning of a pair of lamps on the base.

FIG. 17 is a two-dimensional view of the blank for the insert of the third embodiment depicting a pair of semi-circular cutouts for securing of a pair of lamps on the base.

FIG. 18 is a perspective view of the fourth embodiment of the invention showing the narrow central trunk arrangement for packaging a lamp within the inventive device without a lampshade.

FIG. 19 is a section view through the fourth embodiment of the invention depicting a lamp without a lampshade packaged within the device.

### DETAILED DESCRIPTION OF PREFERRED EXEMPLARY EMBODIMENTS

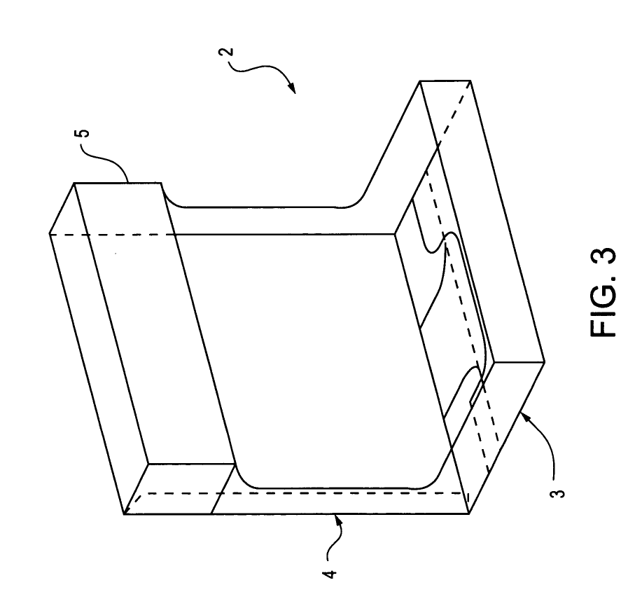

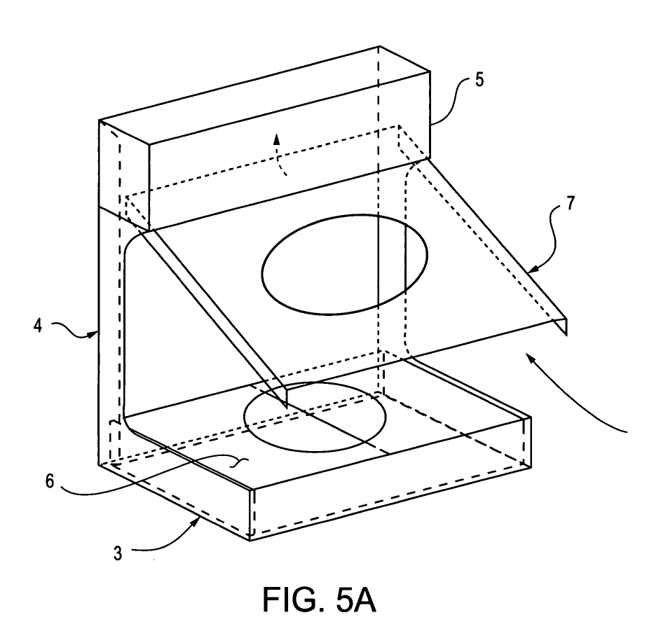

Turning now to a more detailed description of the present invention, and as is illustrated in FIG. 5B, in a first embodiment, the packaging device comprises a shipping, storage and display carton 1 having a bottom receptacle 3, a central trunk 4, a top hood 5, a base support 6 and a separation insert 7. As illustrated in FIG. 3, the bottom receptacle 3, the central trunk 4 and the top hood 5 collectively comprise a packaging shell 2. Shell 2, support 6 and insert 7 are each formed from a respective single manufactured blank, comprising cardboard or other suitable material which has been cut, punched and scored as necessary to facilitate folding of the blanks and locking them to form their respective shapes.

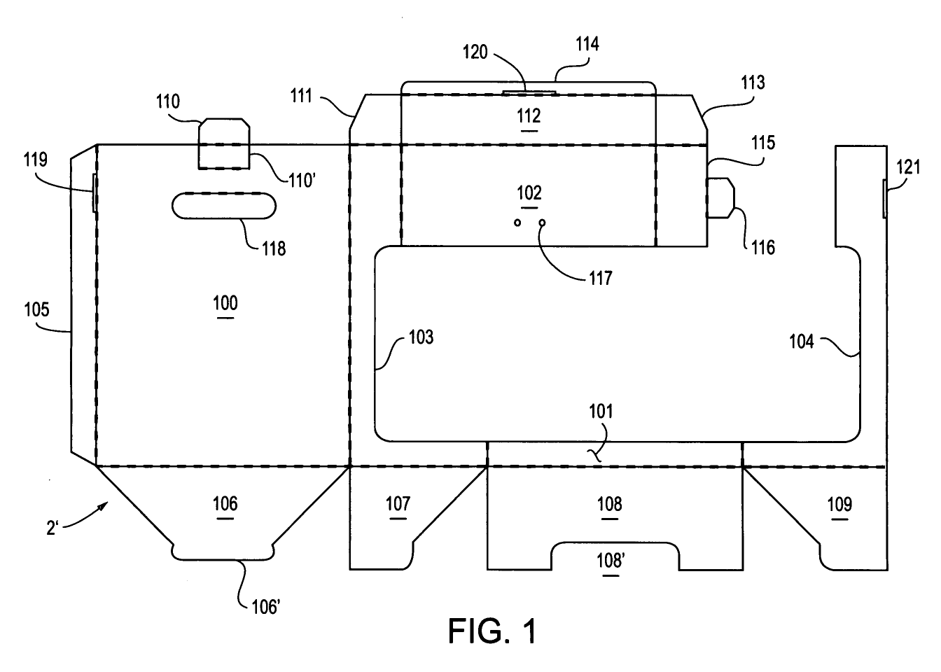

Shell 2 is formed from assembly blank 2′. As shown in FIG. 1, blank 2′ comprises areas delineated by cuts or scores. The surface shown represents the inside of the shell before forming the blank. The delineated areas of the pre-formed blank include a back 100, receptacle front 101, hood front 102, right side 103, left side 104, side flap 105, male bottom flap 106 with tongue 106′, right bottom flap 107, female bottom flap 108 with groove 108′, left bottom flap 109, top lock flap 110, top hinge flap 110′, right top flap 111, top 112, left top flap 113, tucking flap 114, left hood side 115, hood lock flap 116, tie-wire holes 117, finger hole/tab 118, inner hood lock slot 119, top lock slot 120 and outer hood lock slot 121. Flaps will be referred to by number to simplify the assembly instructions which follow.

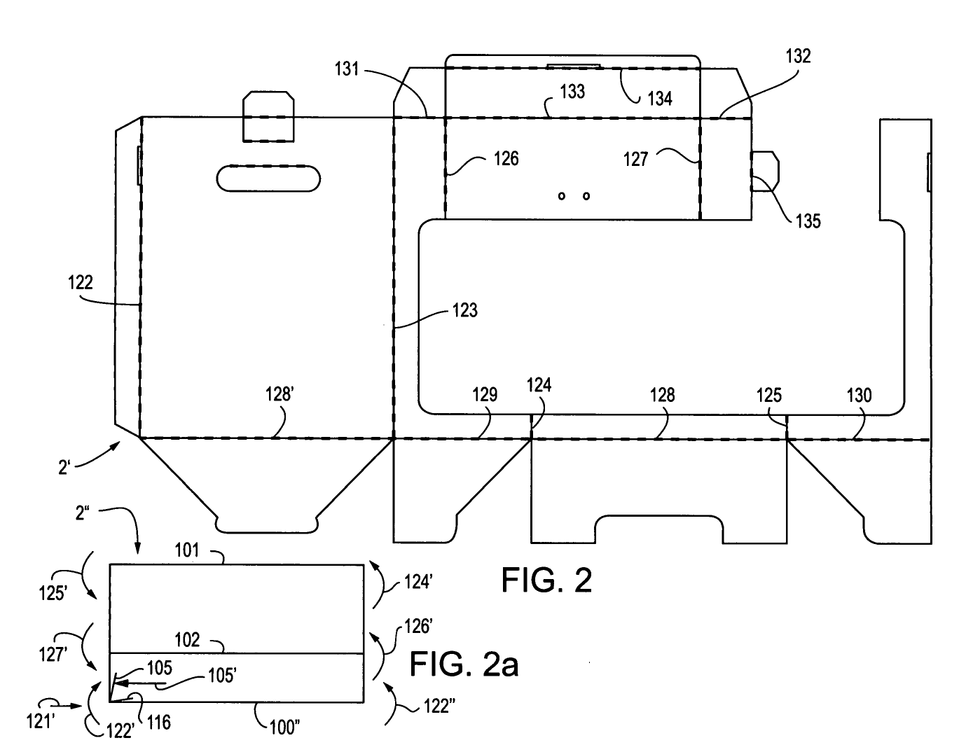

To form shell 2, as shown in FIG. 2, fold flap 105 along line 122 as prescribed by fold line 122′. Then fold back 100 along line 123 as prescribed by fold arrow 122″. Next fold receptacle front 101 toward back 100 along line 124 as prescribed by fold arrow 124′. Then fold left side 104 toward side flap 105 along line 125 as prescribed by fold arrow 125′. Place side 104 against the outside of flap 105 as indicated in FIG. 2 so that slots 119 and 121 are aligned. Press flap 105 back against side 104 along line 122 as indicated by arrow 105′. Then fold hood front 102 toward back 100 along line 126 as prescribed by fold arrow 126′. Fold left hood side 115 across left side 104 as along line 127 as prescribed by fold arrow 127′. Bend flap 116 along line 135 and tuck into aligned slots 119 and 121 as prescribed by arrow 121′. The assembly now comprises a partially completed tubular-shaped shell assembly 2″ with a top end adjacent to hood front 102 and a bottom end adjacent to receptacle front 101.

Complete the bottom of the assembly by first folding flap 108 along fold line 128 toward flap 106, then folding flaps 107 and 109 along lines 129 and 130 respectively against flap 108. Finally, fold flap 106 along line 128′ against flaps 107 though 109, tucking tongue 106′ into groove 108′ to form an enclosed bottom receptacle 3.

Next complete the top of the assembly by first folding flaps 111 and 113 along lines 131 and 132 respectively, over the opening at the top end of the shell. Then fold flap 112 along line 133 against flaps 111 and 113. Next fold flap 114 down along line 134 and tuck flap 114 between the inside surface of back 100 and the free edges of flaps 111 and 113. Finally, using the hinge mechanism of flap 110/110′, tuck flap 110 into slot 120 to lock flap 114 into position. While some details of the above assembly are not shown in figure form, it is assumed that any person skilled in the art of package manufacture will be able to understand the steps involved in assembly.

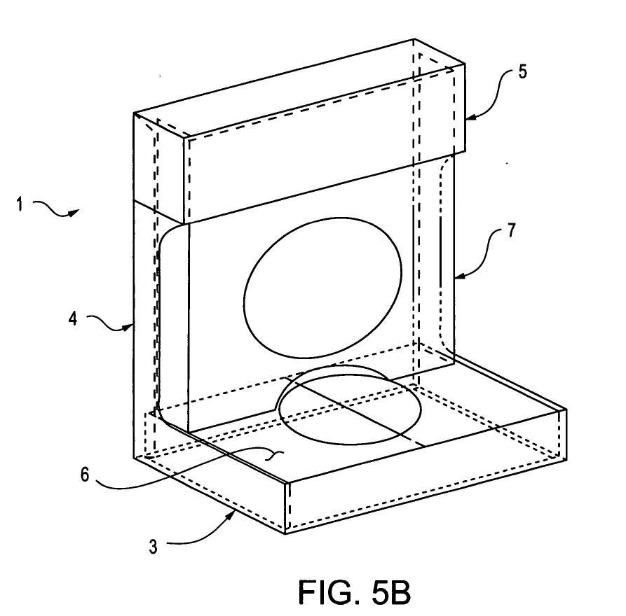

Similarly to shell 2, base support 6 is made from a single blank 6′. As shown in FIG. 6, it also comprises sections defined by cut and score lines. Those sections include left side 136, left outer panel 137, left slotted side 138 with slot 139, left inner panel 140, support top 141, alignment hole 142, right inner panel 143, right slotted side 144 with slot 145, right outer panel 146, right side 147, lower panel 148, lower bridge 149, lower flaps 150 and 150′, upper flap 151, upper bridge 152, upper flaps 153 and 153′.

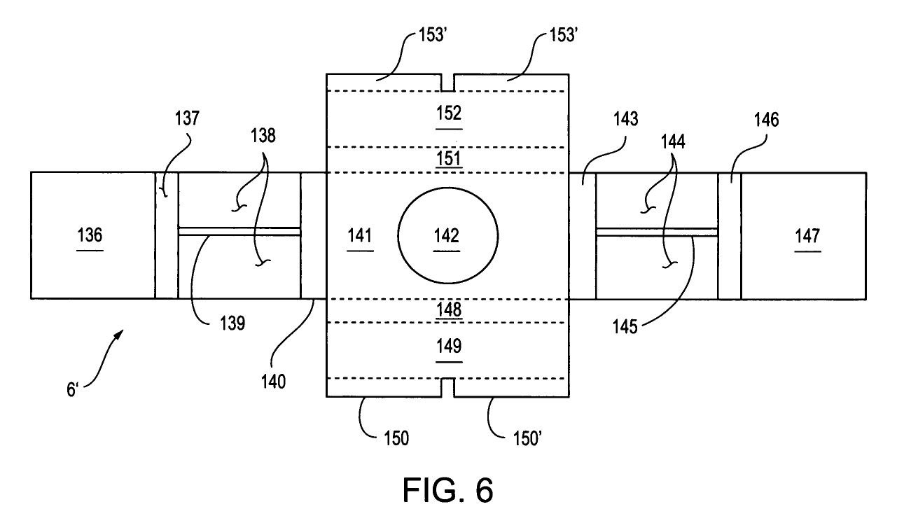

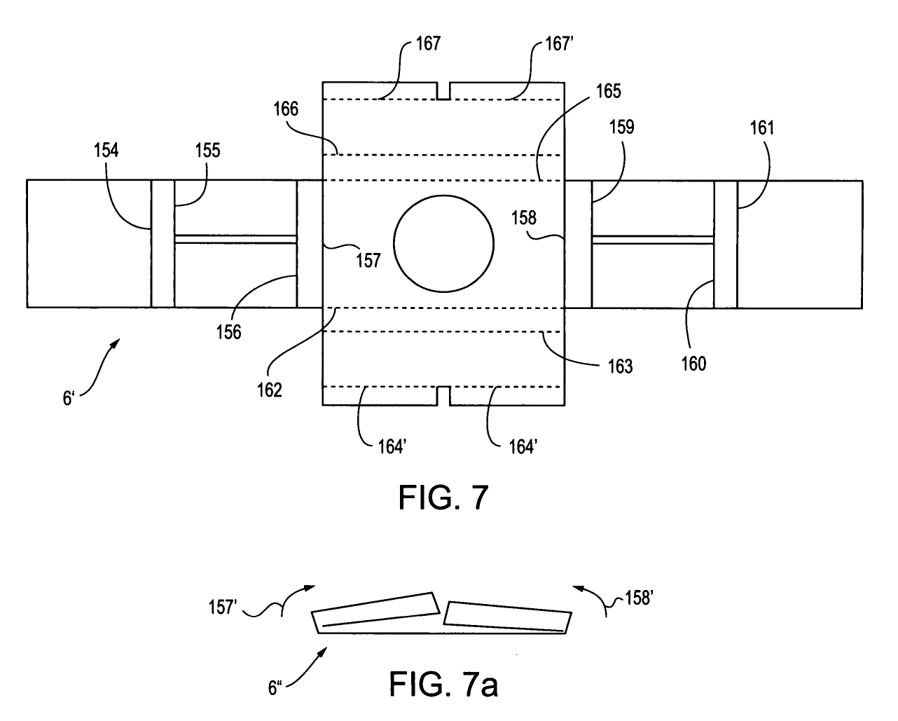

To form base 6, as indicated in FIG. 7, fold side 136 and 147 toward each other along lines 154 and 161 respectively and then fold panels 137 and 146 toward each other along lines 155 and 160. Next, fold slotted sides 138 and 144 toward each other along lines 156 and 159 respectively and then fold panels 140 and 143 along lines 157 and 158 respectively and as prescribed by fold arrows 157′ and 158′ respectively. Blank 6′ now has the configuration of 6″ which is shown in both FIG. 7 and FIG. 8.

Continuing the assembly, fold panels 148 and 151 along lines 162 and 165 respectively and fold bridges 149 and 152 along lines 163 and 166 respectively, each as prescribed by arrows 163′ and 166′ respectively for assembly 6′″. To finish assembling the base, fold fold flaps 150 and 150′ along lines 164 and 164′ respectively and fold flaps 153 and 153′ along lines 167 and 167′ respectively and tuck flaps 150 and 153 into slot 139 and tuck flaps 150′ and 153′ into slot 145 as shown in assembly 6′″.

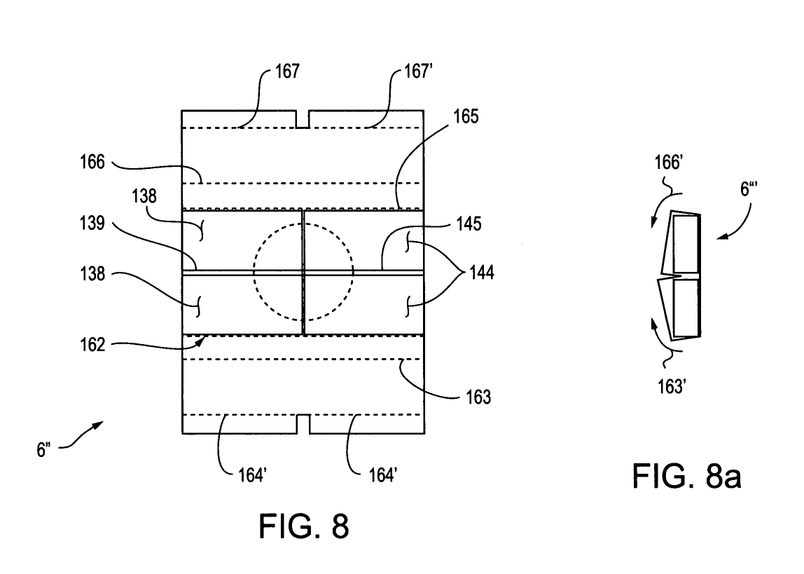

As shown in FIG. 9, insert 7 is also made from a single blank comprising a left side flap 168, a right side flap 169 and a face 170 with hole 171 and cut-out 172. However, insert 7 also comprises a transparent protective cover 173 for hole 171. Cover 173 is attached to the inside surface (shown) of blank 7′ with glue or any other suitable attachment means to create a window over hole 171.

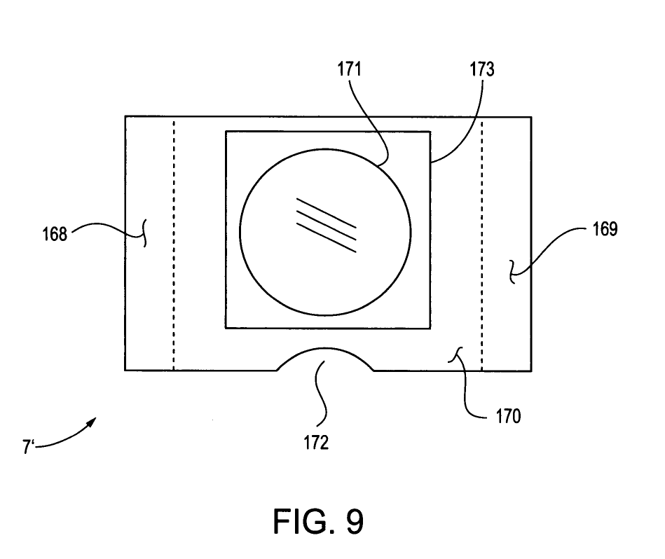

To form insert 7, flaps 168 and 169 are folded along lines 174 and 175 as shown in FIG. 10 and as prescribed by fold arrows 174′ and 175′ respectively. This completes the assembly of insert 7.

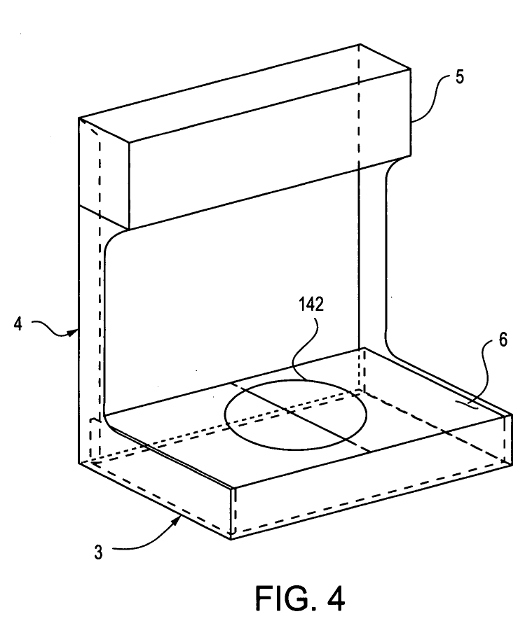

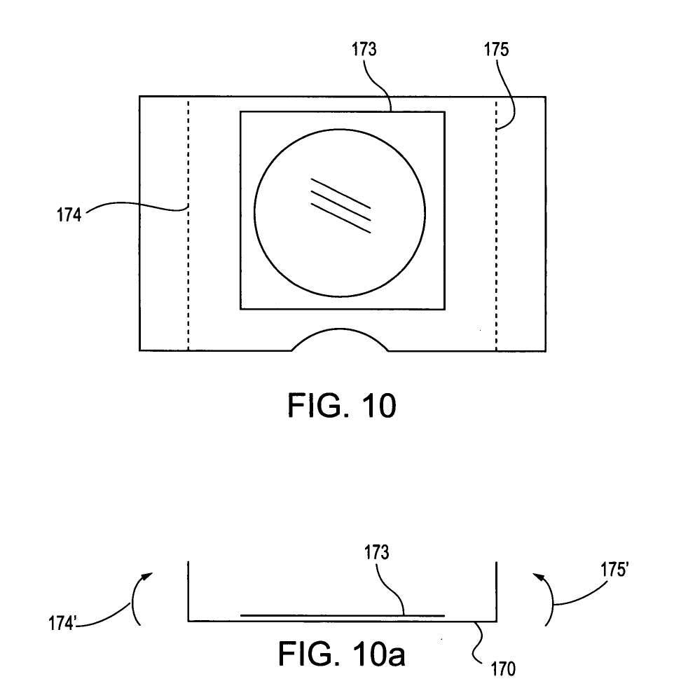

To assemble the packaging device, base 6 is placed into bottom receptacle 3 of shell 2 as shown in FIG. 4. Base 6 now serves as a base of support for separation insert 7 and for a lamp (not shown in FIG. 4, but shown in FIG. 11) to be shipped, stored or displayed within the device. Hole 142 is sized to accept the base of said lamp. As shown in FIG. 5A, separation insert 7 slides up into top hood 5 and serves to separate a collapsible lampshade (not shown in FIG. 5A, but shown in FIG. 11), which is stored behind insert 7 and within central trunk 4, from the lamp seated on the base. The lamp shade color and texture are visible through the transparent material of protective cover 173.

FIG. 11 depicts a lamp 176 seated on base 6 within the fully-assembled packaging device. Collapsible lampshade 177 is shown stored behind insert 7. A shade support harp (not shown) may also be stored in the central trunk area. The base of the lamp projects through cut-out 172, securing it to base 6. Tie-wire 178 is shown projecting through holes 117 and wrapped around the top of lamp 176 to secure it in place against hood front 102. Finger hole 118 is used to carry the device with lamp and lampshade stowed as described above.

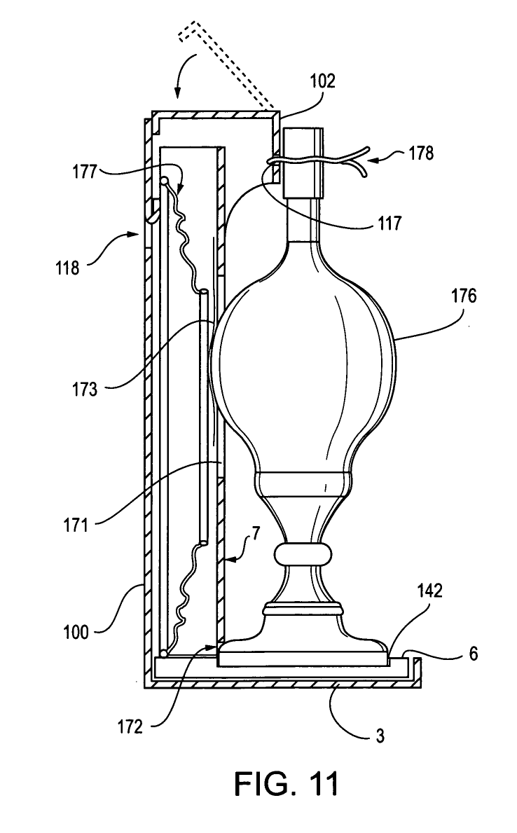

In a second embodiment, as shown in FIG. 12, the packaging device is redesigned to facilitate nested storage. In this embodiment the device 1A comprises a bottom receptacle 3A, a central trunk 4A, a top hood 5A, a base 6A, a bottom front 6A′ and an insert 7A.

In this embodiment, receptacle 3A is located to one side of center of the device, with base front 6A′ located on the other side. In this configuration, a pair of the devices may be stored face to face, nesting their relative receptacles 3A against each other, minimizing the amount of shipping space required for the pair of boxes.

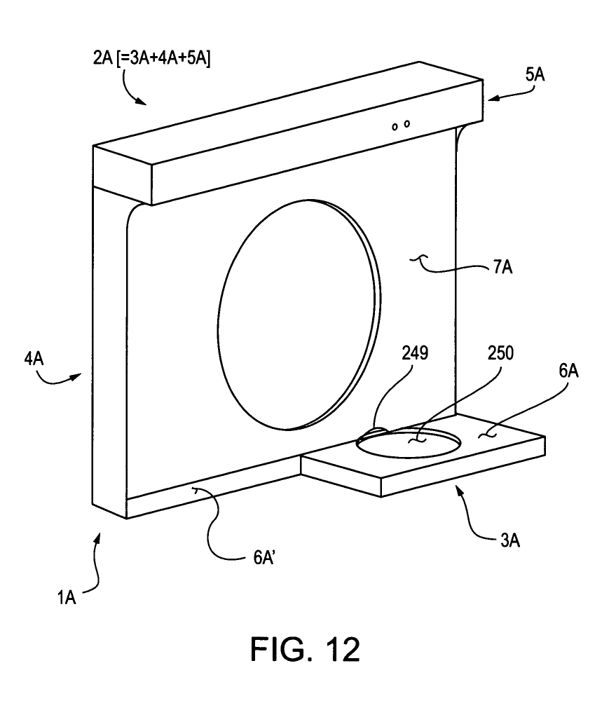

Similar to the previous embodiment, receptacle 3A, central trunk 4A and top hood 5A comprise shell 2A, which is manufactured from a single blank 2A′ as shown in FIG. 13. Blank 2A′ is also comprised of areas delineated by either cuts or scoring, said areas consisting of back 200, receptacle front 201, receptacle side 202, bottom front 202′, hood front 203, left side 204, right side 205 with outer side hood locking slot 222, side flap 206 with inner side hood locking slot 221, bottom lip 207 with lip flap 207′, bottom front face 208, a bottom shelf 209, a bottom tuck flap 210, a male bottom flap 211 with tongue 211′, bottom side flap 212, female bottom flap 213 with groove 213′, left hood side 214, hood lock flap 215, hood top 216, right hood top flap 217, right hood top flap 218, tucking flap 219 with top locking slot 223, top locking flap 220 with top hinge flap 220′, tie-wire holes 224 and finger hole/tab 225.

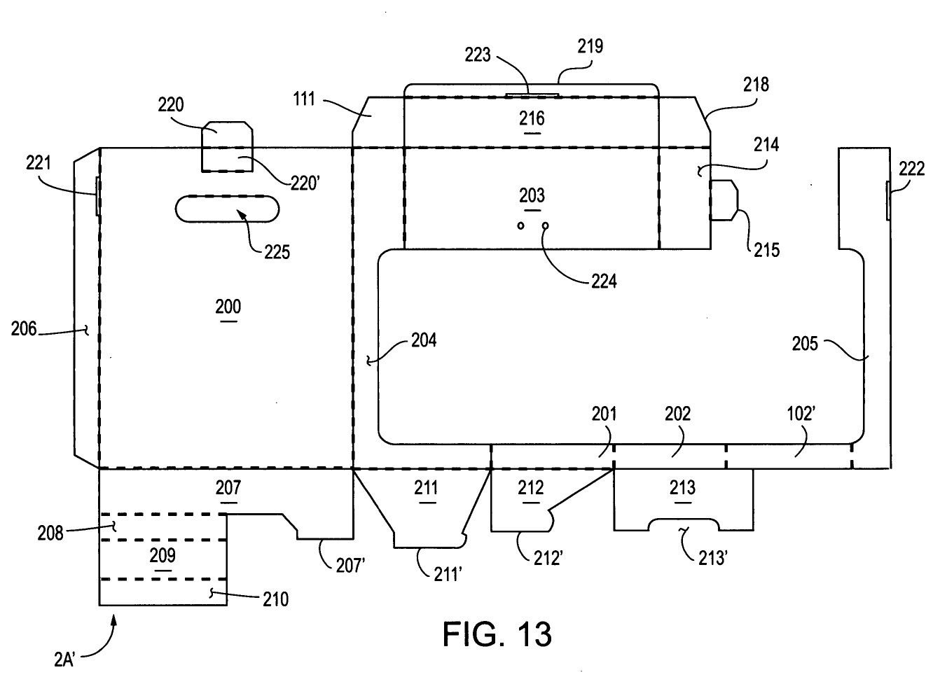

To form shell 2A, first fold blank 2′ along fold line 226, pressing flap 105 as prescribed by fold arrow 226′ shown in FIG. 14. Next, fold side 204 along fold line 227 as prescribed by fold arrow 227′. Then fold front side 201 along fold line 232 as prescribed by fold arrow 232′. Fold side 205 along fold line 234 as prescribed by fold arrow 234′, placing side 205 against flap 106. Impress fold line 234 along arrow 234″ forcing flap 213 to separate from side 205 along cut line 235. Next, fold hood front 203 along fold line 239 and then fold side 214 along line 240 against side 205. Tuck locking tab 215 into slot 222 and then through slot 221, locking hood 5A in place. The assembly now comprises a partially completed tubular-shaped shell assembly 2A″ with a top end adjacent to hood front 203 and a bottom end adjacent to receptacle front 201.

To complete assembly of the shell, first fold flaps 213, 212, 207 and 211 to complete closure of bottom receptacle 3A in a manner similar to the first embodiment. Then fold bottom front face 208 along fold line 237, and bottom shelf 209 along first fold line 239 and then fold line 238. Tuck bottom tuck flap 210 in along the inside of back 200, completing bottom front 6A′. Complete assembly of the hood by closing the top of the shell in a manner similar to that of the first embodiment. While some details of the above assembly are not shown in figure form, it is assumed that a person skilled in the art of package manufacture will be able to understand the steps involved in its assembly.

Base 6A and insert 7A are similar in design to base 6 and insert 7 except that cutout 249 in insert 7A as shown in FIG. 12 (similar to 172 as shown in FIG. 9) is offset to line up with hole 250 in base 6A (similar to 142 as shown in FIG. 4). Base 6A is placed into receptacle 3A and insert 7A is inserted into hood 5A in a manner similar to that indicated in FIGS. 4 and 5A/B, respectively for the first embodiment.

A lamp may be placed on the device of the second embodiment with its base in hole 250 and projecting through cutout 249, in a manner similar to that shown in FIG. 11, and tie-wire may be threaded through holes 224 to secure the lamp to the device. Prior to placing insert 7A into hood 5A, a collapsible shade and shade support harp may be installed in the central trunk in a manner similar to that shown in FIG. 11. The device may be lifted and carried by inserting fingers through tab/hole 225.

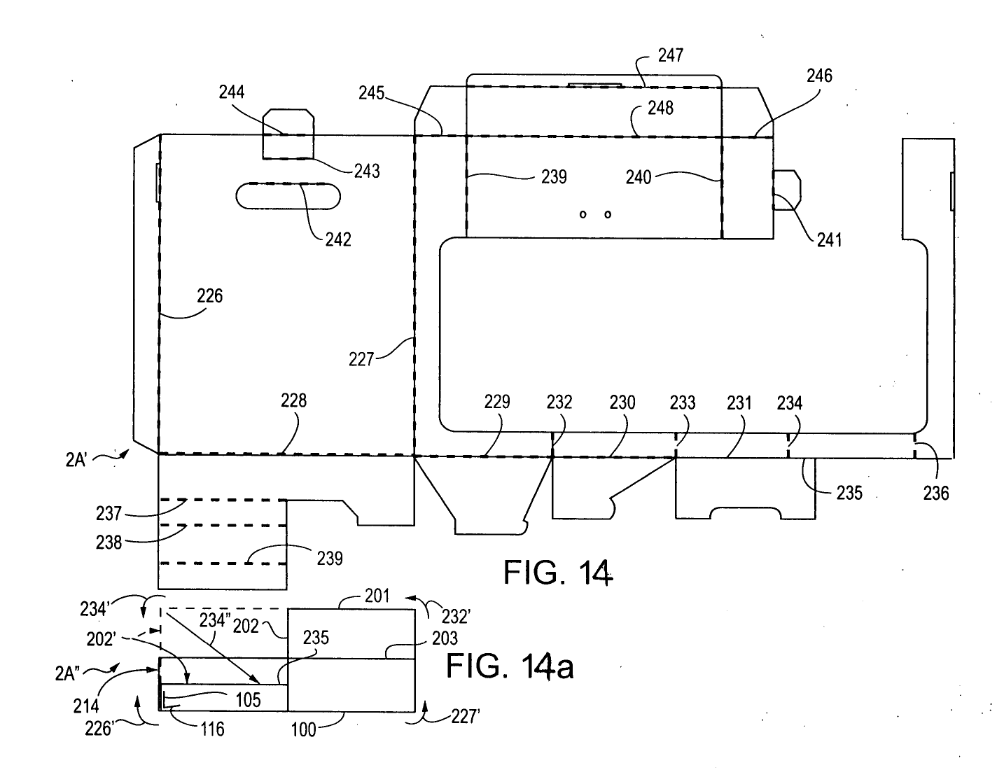

In a third embodiment of the invention, as shown in FIG. 15, a packaging device 1B comprises a shell 2B made up of bottom receptacle 3B, a central trunk 4B and a hood 5B in a manner similar to the previous two embodiments. Also included in the device are base 6B and insert 7B.

Shell 2B is similar in features to shell 2 of the first embodiment except that it is may be wider to accommodate a pair of lamps (not shown). The blank for shell 2B is of the same general layout as 2′, with the exception of its dimensions and an extra pair of tie-wire holes (shown as 117 in FIG. 1).

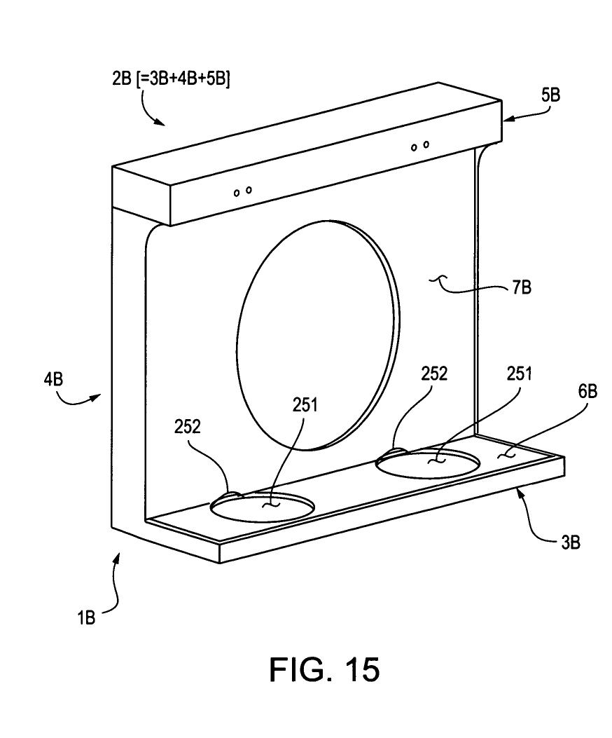

Base 6B is comprised of a single blank, 2B′. As shown in FIG. 16, blank 6B′ is similar in general appearance to blank 6′ of FIG. 6 with the exception that blank 6B′ includes a pair of holes 251. These holes are sized to accommodate the bases of two lamps (not shown). Otherwise, the blank is folded and formed in a manner similar to that of base 6 of the first embodiment.

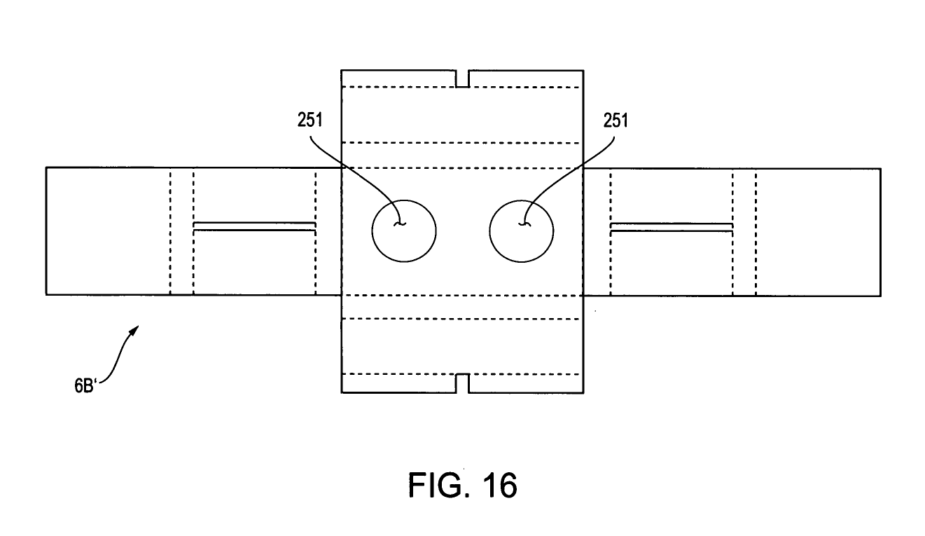

Similar to the modification of base 6B above, insert 7B is also modified in this embodiment to accommodate two lamps. As shown in FIG. 17, insert blank 7B′ includes a pair of cutouts 252 at the bottom of the blank. These cutouts are positioned laterally along the bottom of the insert to coincide with the centers of holes 252 of base 6B.

When assembled, packaging device 1B of this third embodiment will accommodate a pair of lamps together with a pair of collapsible lampshades/harps stored behind insert 7B. The assembly with lamps and shades packaged for shipment, storage or display is similar to that depicted in FIG. 11, which applies to each of the other two embodiments.

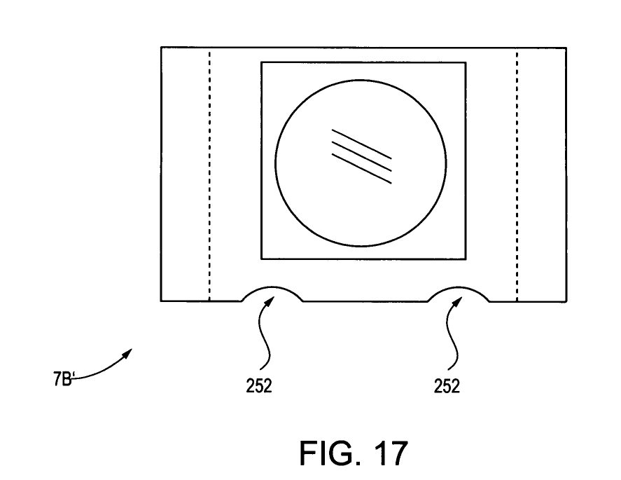

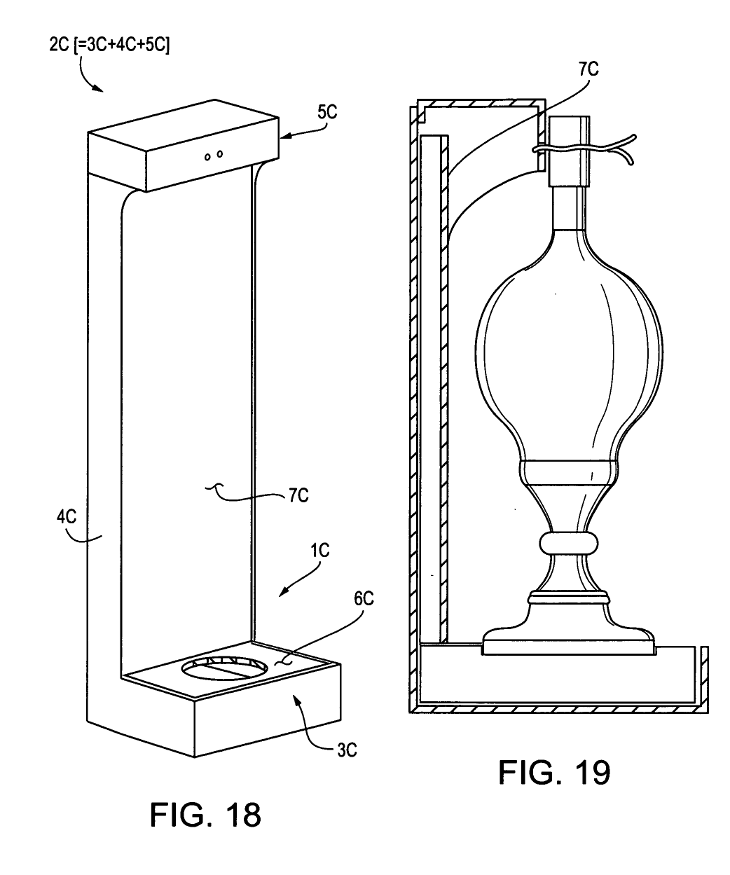

In a fourth embodiment, the inventive packaging device 1C is arranged as a single lamp holding carton as shown in FIG. 18. This embodiment is very similar to the arrangement of the first embodiment except that in this embodiment, is designed to house no collapsible shade behind its insert. In this case, shell 2C, comprised of receptacle 3C, trunk 4C and hood 5C, is created from a blank (not shown) similar in design to that of 2′ of FIG. 1 of the first embodiment. Base 6C is similarly developed from a blank (not shown) generally as depicted in FIG. 6. Insert 7 appears very similar to that of 7′ in FIG. 9, except that it has no hole, clear cover nor cutout. The insert is designed such that there is little space between it and the back of the carton since there is no shade stored in central trunk area 4C. However, in this embodiment, there is still enough space behind insert 7C for a lampshade harp to be stored in the trunk area. The fourth embodiment with a lamp displayed is depicted in FIG. 19.

The base of each embodiment is described with a hole for accepting and securing the base of a lamp. An alternate embodiment, for example punch outs to accept feet on the base of the lamp may be utilized without departing from the teachings of the present invention.

Similarly, the insert is depicted throughout the description as having a hole with a clear window cover. The insert may have multiple holes or other openings, or may have no openings and may be manufactured with or without the clear cover without departing from the teachings of the invention.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A packaging device for packing, shipment, storage and display of lighting lamps and associated accessories comprising the primary components of:
a shell having a bottom receptacle, a central trunk opening and a top hood;
a support base positioned in said bottom receptacle; and
a trunk insert positioned in said central trunk extending partway into said hood and resting on said base positioned within said bottom receptacle, and
an enclosed cavity within said central trunk formed on a front side by said insert and bordered on at least one side by said hood and said positioned base.

2. The device of claim 1 wherein said lighting lamps and associated accessories comprise electric lamps, collapsible shades including associated shade supports, shade mounting hardware and electrical connection cords.

3. The device of claim 1 wherein said shell exists in three dimensions and is comprised of a single two-dimensional blank, with sectional areas delineated by a combination of cut, perforated and scored lines, which is folded and interconnected to form said shell and which is designed to accommodate said base and insert in a manner which will accommodate packaging of said lamp and accessories.

4. The device of claim 1 wherein said base exists in three dimensions and is comprised of a single two-dimensional blank, with sectional areas delineated by a combination of cut, perforated and scored lines, which is folded and interconnected to form said base and which is designed to fit into said bottom receptacle of said shell.

5. The device of claim 1 wherein said insert exists in three dimensions and is comprised of a single two-dimensional blank, with sectional areas delineated by a combination of cut, perforated and scored lines, which is folded to form said insert and which is designed to fit into said central trunk of said shell.

6. The device of claim 5 wherein said insert further comprises a viewing hole located so as to enable a viewer to be able to view inside said enclosed cavity.

7. The device of claim 6 wherein said insert further comprises a clear covering placed over said viewing hole.

8. The device of claim 1 wherein said shell, base and insert are sized to collectively accommodate packaging of said lamp and associated accessories.

9. The device of claim 8 wherein said packaging comprises:
storing a collapsible lampshade and associated supports and mounting hardware within said enclosed cavity;
placing a lamp associated with said collapsible lampshade onto said base;
securing said lamp to said hood with a fastening mechanism.

10. The device of claim 1 wherein said bottom receptacle is located to one side of said device in a manner which will accommodate nesting of a pair of said devices in a face-to-face manner.

11. The device of claim 1 wherein said shell, base and insert are sized to collectively accommodate packaging of a pair of said lamps and associated accessories in a side-by-side manner.

12. The device of claim 11 wherein said packaging comprises:
storing a pair of collapsible lampshades and associated supports and mounting hardware within said enclosed cavity;
placing a pair of lamps associated with said collapsible lampshades onto said base;
securing said lamps to said hood with a pair of fastening mechanisms.

13. The method of claim 1 wherein said lighting lamps and associated accessories comprise electric lamps, shade mounting hardware and electrical connection cords.

14. The device of claim 8 wherein said packaging comprises:
storing lampshade mounting hardware within said enclosed cavity;
placing a lamp associated with said mounting hardware onto said base;
securing said lamp to said hood with a fastening mechanism.

15. The method of claim 9 wherein said fastening mechanism comprises a pair of securing holes in said hood and a length of tie-wire threaded through said securing holes and wrapped around said lamp.

16. The method of claim 12 wherein said fastening mechanism comprises a pair of securing holes in said hood, one for each of said pair of lamps, and a length of tie-wire threaded through each pair of said securing holes and wrapped around each of said pair of lamps.

17. The method of claim 14 wherein said fastening mechanism comprises a pair of securing holes in said hood and a length of tie-wire threaded through said securing holes and wrapped around said lamp.
